(19) United States
(12) Patent Application Publication
(10) Pub. No.: US 2008/0298202 A1
(43) Pub. Date: Dec. 4, 2008

(54) RECORDING APPARATUS AND RECORDING METHOD

(75) Inventor: Ryo Ogata, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/130,210

(22) Filed: May 30, 2008

(30) Foreign Application Priority Data
May 31, 2007 (JP) 2007-145801

(51) Int. Cl. G11B 3/64

(52) U.S. Cl. 369/84; G9B/3.097

(57) ABSTRACT

According to one embodiment, there is provided a recording apparatus including a recording unit which copies first contents with a first number of producible copies and records second contents with a second number of producible copies in a recording region, and a management unit which arbitrarily distributes the second number of producible copies from the first number of producible copies when the recording unit copies the first contents to record the second contents in the recording region and, thereby rewrites the first number of producible copies with a new first number of producible copies subtracted by the distributing process and the copy process of the contents.

### CROSS-REFERENCE TO RELATED APPLICATION

This application is based upon and claims the benefit of priority from Japanese Patent Application No. 2007-145801, filed May 31, 2007, the entire contents of which are incorporated herein by reference.

### BACKGROUND

1. Field

One embodiment of the invention relates to a recording apparatus and a recording method that perform a copy process of contents with the number of producible copies.

2. Description of the Related Art

In recent years, with popularization of digital technologies, digital contents are usually copied by a large number of users. Accordingly, in the sense of copyright protection and adjustment of user convenience, a method of managing contents by limitation information which limits a copy count value is known.

Jpn. Pat. Appln. KOKAI Publication No. 2006-114089 discloses the following technique. When contents are copied, one copy operation permits one copy to be created. When digital information is moved to another recording medium, the number of times of permission is reduced to update copy count information, and the digital information and the copy count information are recorded on the recording medium again.

The conventional technique of above document has the following purpose. That is, although a copy of contents having copy limitation information is described, one copy of contents is created on a recording medium serving as a copy destination by one copy operation. Therefore, a plurality of copies of contents permitted to be copied a plurality of times are not created on a medium serving as a copy destination.

Therefore, when contents purchased by a user have 10 of the number of producible copies, and, for example, copy contents having 8 of the number of producible copies are to be created in a memory or the like, the same copy operation must be repeated eight times. In this case, the contents which can be created on the memory do not have the number of producible copies, and the copy cannot be created any more from the contents on the memory in another device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of a configuration of a recording apparatus according to an embodiment of the present invention;

FIGS. 2A to 2D are diagrams for explaining an example of a copy process in a recording apparatus according to one embodiment of the present invention;

FIGS. 3A to 3D are diagrams for explaining an example of a copy process in a recording apparatus according to one embodiment of the present invention;

FIGS. 4A to 4D are diagrams for explaining an example of a copy process in a recording apparatus according to one embodiment of the present invention;

FIG. 5 is a diagram for explaining an example of a set screen in a copy process in a recording apparatus according to one embodiment of the present invention;

FIG. 6 is a diagram for explaining another example of a set screen in a copy process in a recording apparatus according to one embodiment of the present invention;

FIG. 7 is a flow chart showing an example of a duplicating process in a recording apparatus according to one embodiment of the present invention;

FIG. 8 is a diagram for explaining an example of an editing process of contents in a recording apparatus according to one embodiment of the present invention; and

FIG. 9 is a flow chart showing an example of a duplicating process of edited contents in a recording apparatus according to one embodiment of the present invention.

### DETAILED DESCRIPTION

Various embodiments according to the invention will be described hereinafter with reference to the accompanying drawings. In general, according to one embodiment of the invention, a recording apparatus comprising: a recording unit which copies first contents with a first number of producible copies and records second contents with a second number of producible copies in a recording region; and a management unit which arbitrarily distributes the second number of producible copies from the first number of producible copies when the recording unit copies the first contents to record the second contents in the recording region and, thereby rewrites the first number of producible copies with a new first number of producible copies subtracted by the distributing process and the copy process of the contents.

One embodiment of the present invention provides a recording apparatus and a recording method that manage the number of producible copies of contents which can be copied a plurality of times.

One embodiment of the present invention is a recording apparatus comprising:

a recording unit (30) which copies first contents (C1) with a first number of producible copies (N1) and records second contents (C2) with a second number of producible copies (N2) in a recording region; and

a management unit (42) which arbitrarily distributes the second number of producible copies (N2) from the first number of producible copies (N1) when the recording unit copies the first contents to record the second contents in the recording region and, thereby rewrites the first number of producible copies (N1) with a new first number of producible copies (N1-1) subtracted by the distributing process and the copy process of the contents.

In this manner, since the number of copies can be distributed within the range of the given number of producible copies, when a plurality of copies are created on the same recording medium, a copy operation can be executed by the same operation regardless of the number of copies to be created.

An embodiment of the present invention will be described below with reference to the accompanying drawings.

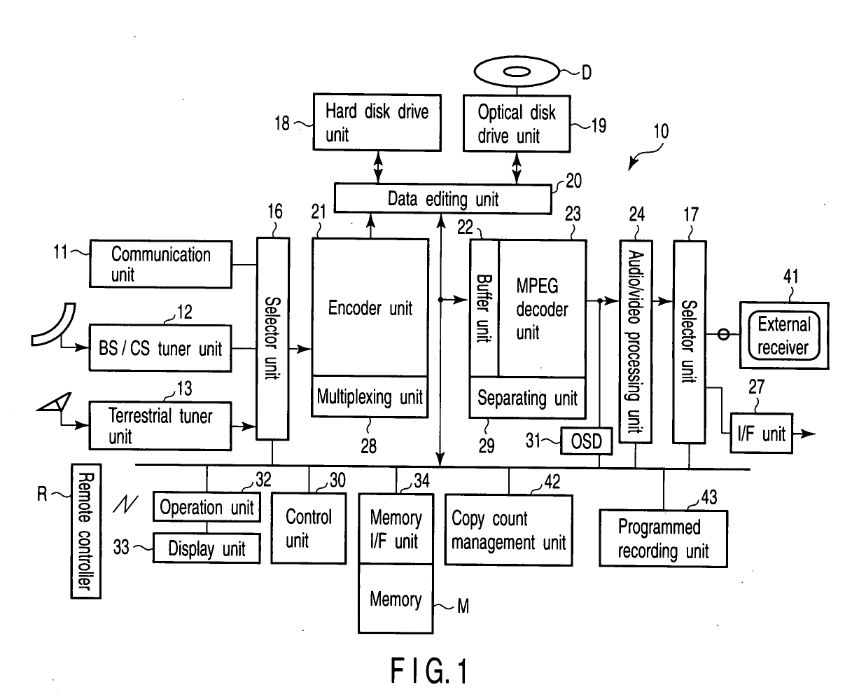

FIG. 1 is a block diagram showing an example of a configuration of a recording apparatus according to an embodiment of the present invention.

### EXAMPLE OF RECORDING APPARATUS ACCORDING TO ONE EMBODIMENT OF THE PRESENT INVENTION

(Configuration)

First, a recording apparatus 10 shown in FIG. 1 has disk drive units of two types. First, the recording apparatus 10 has an optical disk drive unit 19 that rotationally drives an optical disk D serving as a first medium serving as an information recording medium on which a video file can be constructed to read or write information. In this case, the optical disk D is, as an example, an HD DVD. However, the optical disk D is not limited to the HD DVD. The recording apparatus 10 also has a hard disk drive unit 18 that drives a hard disk serving as a second medium. A control unit 30 is connected to respective units through a data bus to control an entire operation.

The recording apparatus 10 shown in FIG. 1 includes, as main constituent elements, an encoder unit 21 constituting a recording side, an MPEG decoder unit 23 constituting a reproducing side, and the control unit 30 that controls an operation of the apparatus main body. The recording apparatus 10 has an input selector unit 16 and an output selector unit 17. A communication unit 11 such as a LAN, a so-called satellite broadcast (BS/CS) tuner unit 12, and a so-called terrestrial tuner unit 13 are connected to the input selector unit 16 to output a signal to the encoder unit 21. A satellite antenna is connected to the satellite broadcast tuner unit 12, and a terrestrial antenna is connected to the terrestrial tuner unit 13. The recording apparatus 10 includes the encoder unit 21, a data editing unit 20 that receives output from the encoder unit 21 and performs desired data processing such as data editing, the hard disk drive unit 18 connected to the data editing unit 20, and the optical disk drive unit 19. Furthermore, the recording apparatus 10 includes the hard disk drive unit 18, the MPEG decoder unit 23 that receives and decodes a signal from the optical disk drive unit 19, the encoder unit 21, a buffer unit 22, the MPEG decoder unit 23, a multiplexing unit 28, a separating unit 29, the control unit 30, an OSD unit 31 that synthesizes a desired video image with a video screen, a memory I/F unit 34 serving as an interface to a detachable memory M, a copy count management unit 42 that manages the number of producible copies, and a programmed recording unit 43 that generates a programming list or a program schedule image. These units are connected to the control unit 30 through a data bus. Furthermore, an output from the selector unit 17 is connected to an external receiver 41 or supplied to an external device through an interface unit 27 which communicates with the external device.

Furthermore, the recording apparatus 10 is connected to the control unit 30 through the data bus and has an operation unit 32 which is operated by a user or a remote controller R. In this case, the remote controller R can perform an operation that is almost the same as that of the operation unit 32 arranged in the main body of the recording apparatus 10 to make it possible to perform various settings such as a recording/reproducing designation or an editing designation of the hard disk drive unit 18 or the optical disk drive unit 19, a tuner operation, and a setting of a programmed recording.

(Basic Operation)

In the recording apparatus 10 having the above configuration, outlines of a reproducing process and a recording process will be described by using an optical disk as an example. More specifically, under the control of the control unit 30, a laser beam is irradiated on the optical disk D rotated at a predetermined speed, a reflected beam is detected by an optical pickup, and a detection signal based on the reflected beam is output. On the basis of the detection signal, an RF signal is generated, and a reproducing process is performed subsequent to a data read process.

In a recording process of the optical disk, under the control of the control unit 30, data supplied through the selector unit 16 through, for example, an input unit (not shown) is supplied to the encoder unit 21, encoded, and output. Depending on the encoded output and an output from the control unit 30, a drive current of a laser driver is supplied to the optical pickup, and a laser is irradiated on a recording region of the optical disk D to perform the recording process.

(Type of Copy Process)

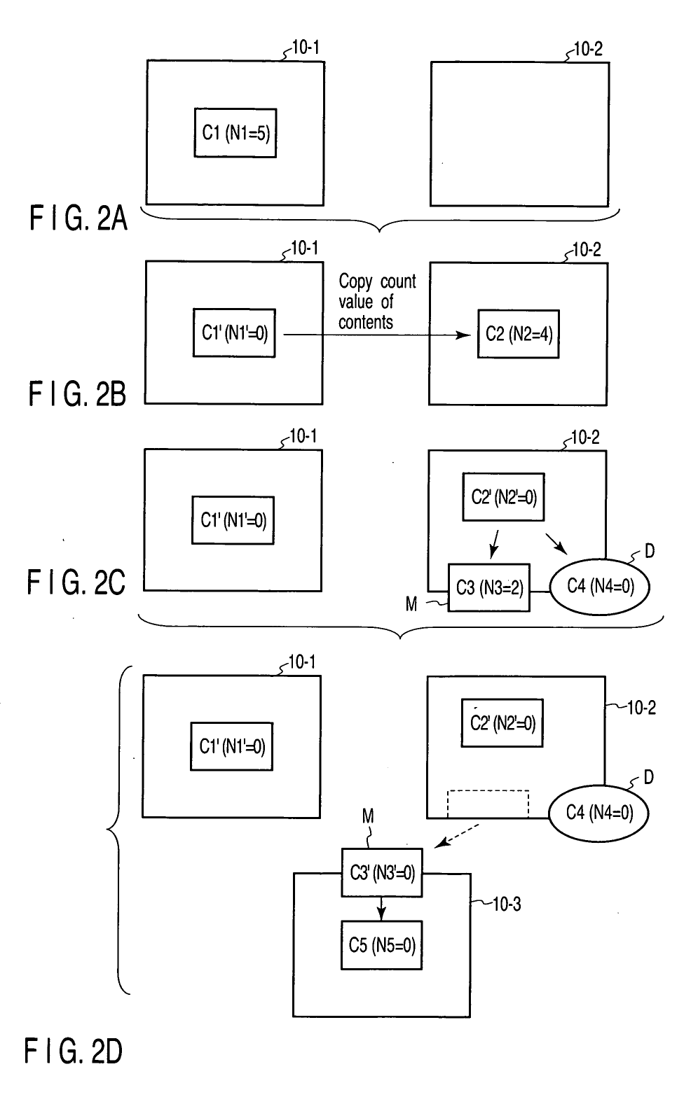

Concrete examples of three duplicating processes in the recording apparatus 10 according to one embodiment of the present invention will be described below with reference to FIGS. 2 to 4. FIGS. 2 to 4 are diagrams for explaining an example of a copy process in the recording apparatus according to one embodiment of the present invention.

Copy Process with Distribution of the Number of Producible Copies (FIGS. 2A to 2D)

First, a copy process with distribution of the number of producible copies will be described below with reference to FIGS. 2A to 2D. In FIG. 2A, as an example, contents information having the number of producible copies N1=5 is purchased by a user through the Internet by using the communication unit 11 or the like, and downloaded on, for example, the hard disk drive unit 18 as C1.

In FIG. 2B, although the contents information is copied on another recording apparatus 10-2, the present copy count value 1 is consumed, and the new number of producible copies N1′=0 is set by distributing the number of producible copies. Furthermore, the number of producible copies N2 of second contents C2 copied on the recording apparatus 10-2 becomes “4”.

In FIG. 2C, on the other recording apparatus 10-2, the second contents C2 are copied as third contents C3 (the number of producible copies N 3=2) and fourth contents C4. The number of producible copies N2′ of the second contents C2″ is “0”.

In FIG. 2D, the third contents C3 become third contents C3′, and the number of producible copies N2′ is “0”. On the other hand, fifth contents C5 receive an allocation from the third contents C3, and the number of producible copies N5 of the fifth contents C5 is “1”.

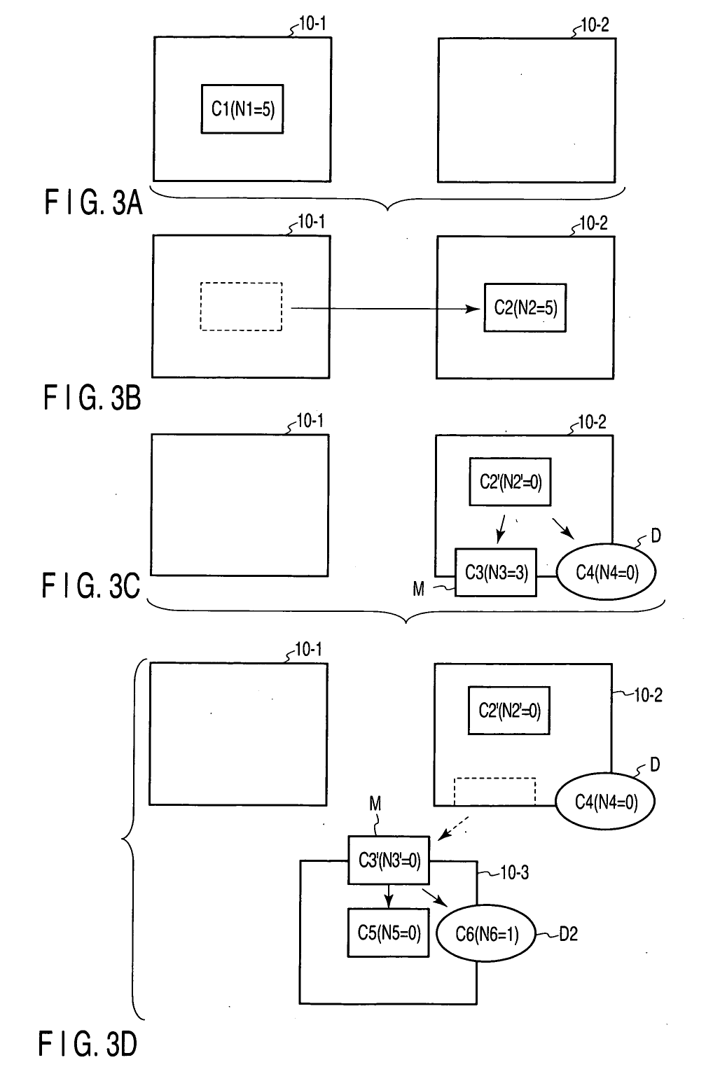

Copy Process with Distribution and Movement of the Number of Producible Copies (FIGS. 3A to 3D)

In FIGS. 3A to 3D, an example of a copy process with distribution and movement of the number of producible copies is shown.

In this case, in FIG. 3B, since the contents C1 completely move to the second contents C2, the number of producible copies is not consumed by this movement. As a result, the number of producible copies in FIG. 3B is smaller than that in FIG. 2B by one.

Therefore, in FIG. 3D, contents C6 hold the number of producible copies N6=1 and are stored in an optical disk D2.

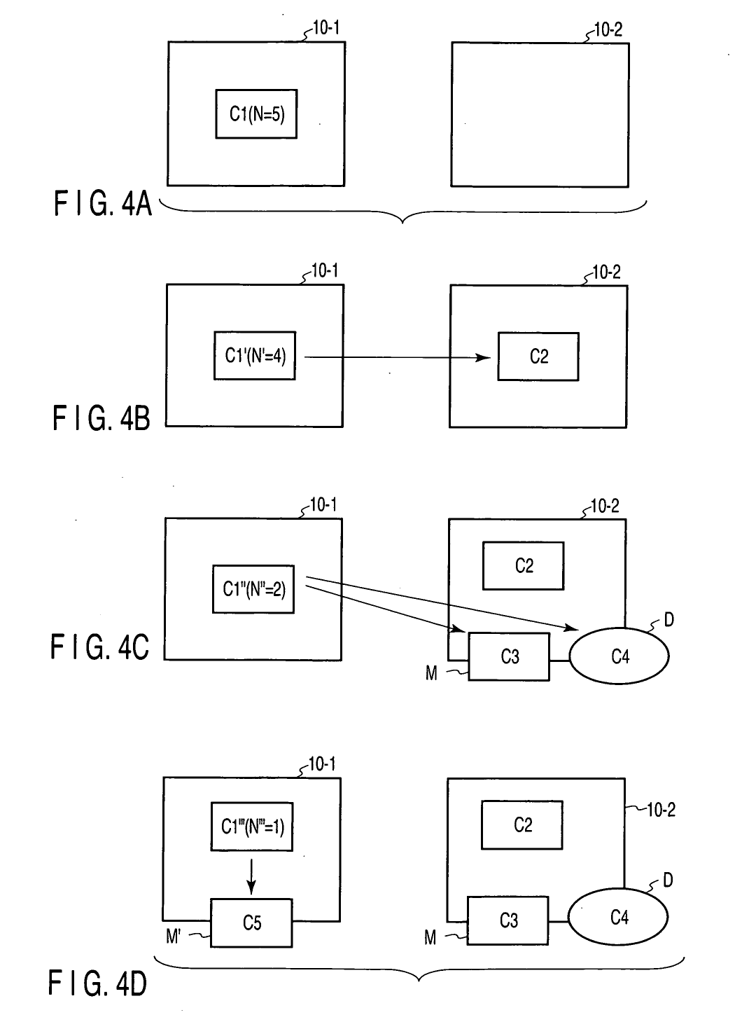

Copy Process Performed when the Number of Producible Copies is not Distributed (FIGS. 4A to 4D)

In FIGS. 4A to 4D, a copy process performed when the number of producible copies is not distributed is shown.

In this case, the copy operation is repeated from the contents C1 of a recording apparatus 10-1 to the second contents C2, the third contents C3, the fourth contents C4, and the fifth contents C5. However, since a distributing process is not performed, contents of a copy-destination do not have the number of producible copies. Therefore, when a user wants to copy the contents, there is a restriction for the user in that the user must copy the contents by operating the recording apparatus 10-1.

The number of producible copies N1 of the contents C1 also monotonously changes while being reduced in proportion to the copy count value.

(Copy Process Operation with the Number of Producible Copies)

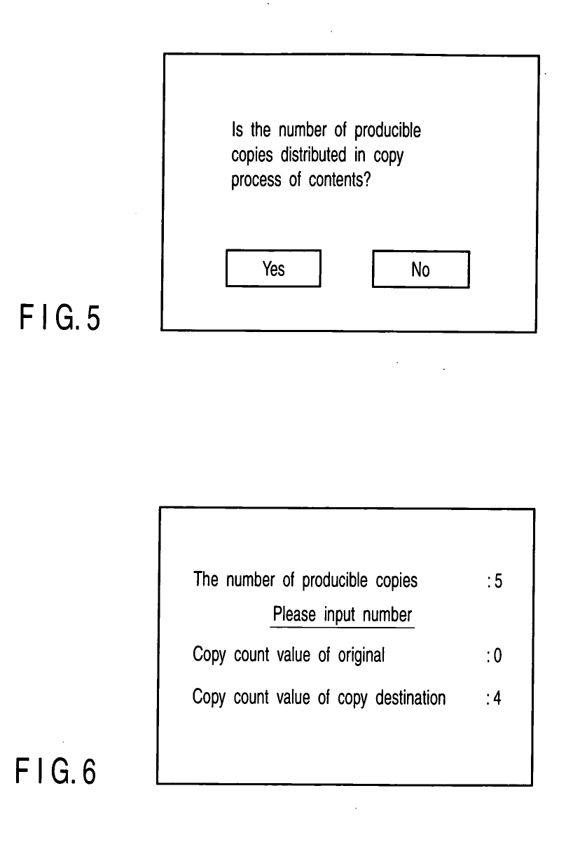

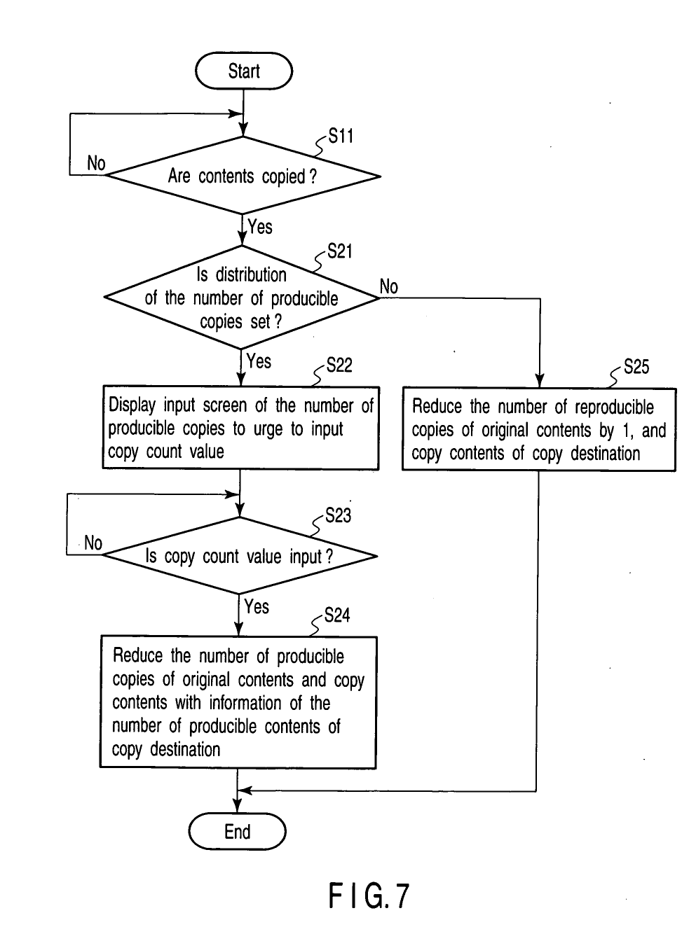

In the recording apparatus 10 having the above configuration and the basic function, a copy process to be executed will be described below in detail with reference to FIGS. 5 to 7. FIG. 5 is a diagram for explaining an example of a set screen in the copy process in the recording apparatus. FIG. 6 is a diagram for explaining another example of a set screen in the copy process in the recording apparatus. FIG. 7 is a flow chart showing an example of a duplicating process in the recording apparatus.

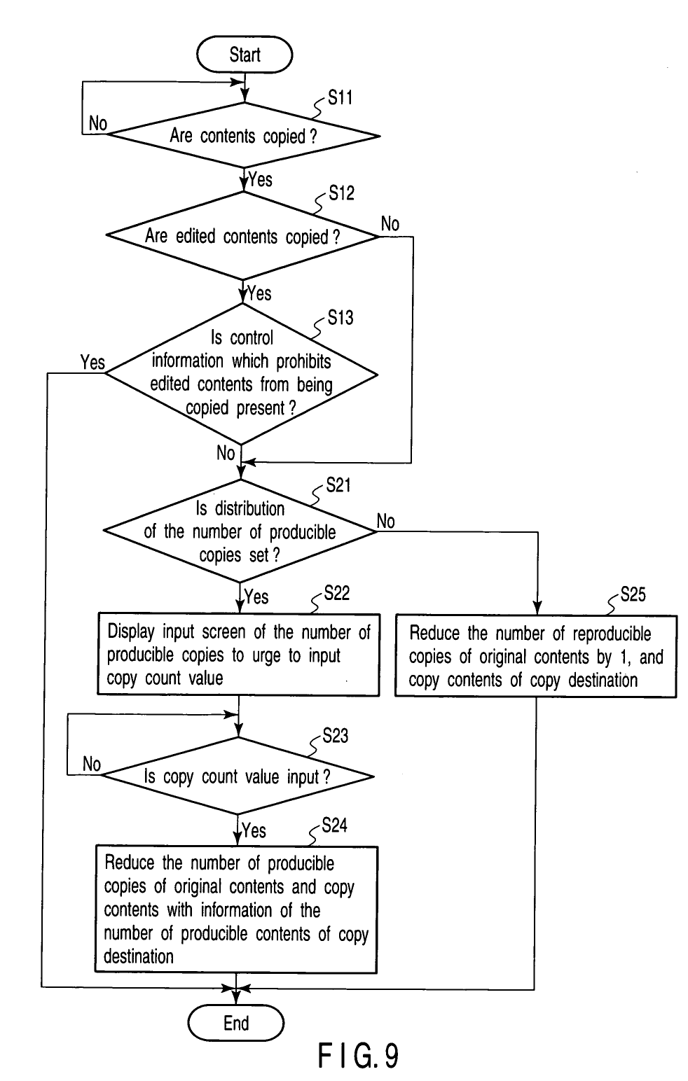

Steps in the flow charts in FIGS. 7 and 9 can be replaced with circuit blocks. Therefore, all the steps in the flow charts can be redefined as blocks.

In the recording apparatus 10 according to the embodiment of the present invention, as shown in the flow chart in FIG. 7, the control unit 30 and the copy count management unit 42, for example, detect the first contents C1 stored in the hard disk drive unit 18 or the like and purchased by a user through the Internet by using the communication unit 11 or the like if the first contents C1 are designed to be copied by the user (step S11).

The control unit 30 and the copy count management unit 42 determine whether the number of producible copies is set to be distributed (step S21). This is set information given by a user operation on the set screen as shown in FIG. 5 and recorded recognizably by the control unit 30 or the like.

In this case, if the distribution is set, the control unit 30 and the copy count management unit 42 shift to step S25, and perform an operation that reduces the number of producible copies of the original contents C1 by one and copies the contents of a copy destination (step S25). This process must be performed to the first recording apparatus 10 as shown in the explanatory diagram in FIGS. 4A to 4D.

If it is recognized in step S21 that the number of producible copies is set to be distributed, the control unit 30 and the copy count management unit 42 shift to step S22. The control unit 30 and the copy count management unit 42 display an input screen for the number of producible copies as shown in FIG. 5 to urge a user to input a copy count value (step S22). On this screen, if the user inputs “4” as a copy count value of the copy destination with respect to “5” of the number of producible copies given first, “0” is automatically displayed as the number of producible copies of the first contents C1′ serving as a copy source. Since one remains as the number of producible copies for a copy process to be performed at the present, the foregoing calculation result is obtained.

The copy process is just a process performed in FIG. 2B. It is understood that the number of producible copies N1′ (=0) of the first contents C1 and the number of producible copies C2 (=4) of the second contents C2 are calculated. More specifically, the number of producible copies N of a new original=(first copy count value)−(distributed copy count value)−1.

When it is recognized that a copy count value is input by a user operation (step S23), the control unit 30 and the copy count management unit 42 display a value obtained by reducing the number of producible copies of the original contents on the screen. The control unit 30 and the copy count management unit 42 perform a copy process of the contents with information of the number of producible copies of the contents of the copy destination (step S24). As a result, for example, a state shown in FIG. 2B is obtained.

In this case, the copy destination of the contents is the hard disk drive unit 18 of the recording apparatus 10. The optical disk D is preferably used by using the optical disk drive unit 19, or the memory M connected to the memory I/F unit 34 is preferably used. Alternatively, an external device connected through the communication unit 11 or the like, i.e., the equivalent recording apparatus 10-2 may be used. Furthermore, a hard disk drive or an optical disk built in the recording apparatus 10-2 connected through the communication line or a memory connected to the I/F unit is preferable. In addition, any electrically communicable recording region is preferably targeted.

The copy process can be continuously performed until the value of the information of the number of producible copies is “0”.

More specifically, in the copy process in the recording apparatus according to one embodiment of the present invention, a plurality of copies can be produced in a medium serving as a copy destination by equivalent operations regardless of the number of copies within the range of the given number of producible copies. Therefore, if contents purchased by a user have 5 as the number of producible copies, for example, copy contents having 4 as the number of producible copies are produced in a memory or the like by one copy operation. The user brings the memory out, and, for example, the user further reads the contents on the memory by using a device in the workplace to make it possible to move the contents onto four media, for example, optical disks.

(Copy Process of Edited Contents)

As another embodiment of a copy process performed by a recording apparatus according to one embodiment of the present invention, a copy process performed when purchased contents are arbitrarily edited by a user will be described below with reference to the accompanying drawings.

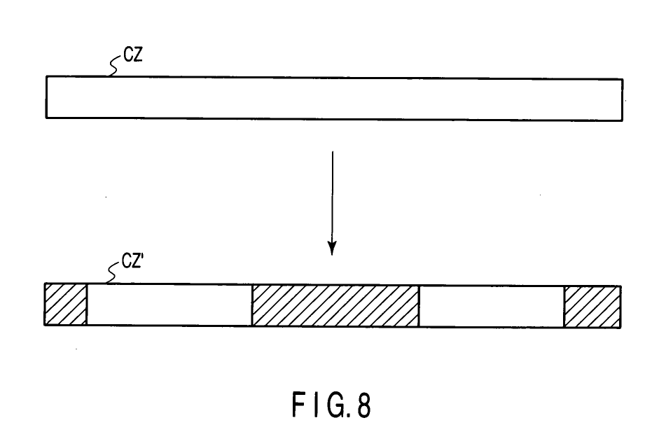

FIG. 8 is a diagram for explaining an example of an editing process of contents in the recording apparatus according to one embodiment of the present invention. FIG. 9 is a flow chart showing an example of a duplicating process of edited contents in the recording apparatus according to the embodiment of the present invention. The flow chart in FIG. 9 has a description common to that of the flow chart shown in FIG. 7, and an explanation thereof will be omitted.

In this case, a target of the copy process is, as shown in FIG. 8, for example, contents CZ′ shortly edited by deleting a part other than a part which is especially viewed by a user from contents CZ purchased as paid contents.

As a method of coping with the contents CZ′ edited as described above, a method of prohibiting the contents CZ′ from being copied is preferably used in terms of copyright protection. In contrast to this, a method of permitting the contents to be freely copied is preferably used. Furthermore, a method is preferably used which does not copy the contents only when the original contents include limitation information which prohibits the edited contents from being copied.

More specifically, in the recording apparatus 10 according to one embodiment of the present invention, as shown in the flow chart in FIG. 9, when the control unit 30 and the copy count management unit 42 recognize that the control unit 30 and the copy count management unit 42 are designated to copy the edited contents (step S12), the control unit 30 and the copy count management unit 42 determine whether contents to be copied have “control information which prohibits edited contents from being copied” (step S13). When it is determined that the contents have the control information, for example, a warning display or the like is performed without performing a copy process in response to a copy instruction from a user to stop the copy process.

However, when it is determined that the contents do not have the “control information which prohibits edited contents from being copied”, the control unit 30 and the copy count management unit 42 perform a normal copy process according to the processes subsequent to step S13.

In this manner, convenience on a user operation can be assured while realizing copyright protection of predetermined contents.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording apparatus comprising:
a recording unit which copies first contents with a first number of producible copies and records second contents with a second number of producible copies in a recording region; and
a management unit which arbitrarily distributes the second number of producible copies from the first number of producible copies when the recording unit copies the first contents to record the second contents in the recording region and, thereby rewrites the first number of producible copies with a new first number of producible copies subtracted by the distributing process and the copy process of the contents.

2. The recording apparatus according to claim 1, wherein the second number of producible copies distributed from the first number of producible copies of the management unit is designated by an operation signal.

3. The recording apparatus according to claim 1, wherein the second number of producible copies distributed from the first number of producible copies of the management unit is designated by an operation signal to an operation screen that urges to input whether a process of distributing a specific number of the number of producible copies is performed.

4. The recording apparatus according to claim 1, wherein the management unit determines an operation mode in which the first number of producible copies is distributed to the second number of producible copies by a setting.

5. The recording apparatus according to claim 1, wherein a recording destination on which the recording unit records the second contents is another recording apparatus connected through a communication path.

6. The recording apparatus according to claim 1, wherein a recording destination on which the recording unit records the second contents is a detachable memory.

7. The recording apparatus according to claim 1, wherein, when the first contents to be copied are contents obtained by editing original contents, the recording unit does not copy the contents.

8. The recording apparatus according to claim 1, wherein, when the first contents to be copied are contents obtained by editing original contents and have limitation information which prohibits the edited contents from being copied, the recording unit does not copy the contents.

9. A recording method comprising:
when first contents with a first number of producible copies are copied and second contents with a second number of producible copies are recorded in a recording region,
arbitrarily distributing the second number of producible copies from the first number of producible copies; and
thereby rewriting the first number of producible copies with a new first number of producible copies subtracted by the distributing process and the copy process of the contents.

10. The recording method according to claim 9, wherein the second number of producible copies distributed from the first number of producible copies is given by an operation signal.
